(19) United States
(12) Patent Application Publication
(10) Pub. No.: US 2016/0326955 A1
(43) Pub. Date: Nov. 10, 2016

(54) METHOD AND APPARATUS FOR OPERATING A COMBUSTION DEVICE

(71) Applicant: ANSALDO ENERGIA IP UK LIMITED, London (GB)

(72) Inventors: Norbert Walter EMBERGER, Neuenhof (CH); Benjamin MEYER, Nussbaumen (CH); Frank BAGUSAT, Wurenlos (CH); Jose CUEVAS-ALVAREZ, Baden (CH)

(73) Assignee: ANSALDO ENERGIA IP UK LIMITED, London (GB)

(21) Appl. No.: 15/145,397

(22) Filed: May 3, 2016

(30) Foreign Application Priority Data
May 4, 2015 (EP) 15166262.4

(51) Int. Cl. F02C 3/30

(52) U.S. Cl. CPC F02C 3/30; F05D 2260/962; F23R 2900/00013

(57) ABSTRACT

The present invention generally relates to the field of combustion technology related to gas turbines. More in particular, the present invention refers to a method for operating a combustion device. Advantageously, a pulsation protective load shedding is avoided by adjusting the parameter ω in case of too high combustion pulsation levels from the standard operation set point. This implies that the dynamic pulsation control logic is activated in case the high frequency pulsation level exceeds a predetermined threshold value and a control unit adjusts the ω, preferably in a stepwise manner, until acceptable and optimum pulsation levels are reached or a maximum reduction of the ω is performed.

### TECHNICAL FIELD

The present invention generally relates to the field of combustion technology related to gas turbines. More in particular, the present invention refers to a method for operating a combustion device.

### BACKGROUND

As well known, an indispensable requisite for achieving an efficient combustion process is the avoidance of combustion instabilities.

Patent publication US 2012/0317986 discloses a method for operating a combustion device having a premix burner equipped with fuel staging and connected to a combustion chamber. The method includes continuously determining a pulsation level of the combustion-induced pulsations which occur in the combustion chamber and changing the fuel staging for lowering the pulsation level if the later exceeds a predetermined threshold. Furthermore, the fuel staging is reset to an undisturbed value corresponding to a respective operating point if the pulsation levels do not exceed the threshold for a predetermined time interval to achieve improved emission behaviour.

In sum, in US 2012/0317986 the pulsation control logic is used to adapt the fuel gas distribution within the burner in case of too high pulsations.

However, it is also important in the combustion process to monitor the total concentration of NO and NO₂ (generally referred to as NOₓ), which cannot exceed predetermined values set by law or local requirements.

On fuel oil operation water injection technology is used for lowering NOₓ emissions, whereby water is introduced in the combustion chamber or, alternatively, is emulsified with fuel oil prior to being injected into the combustion chamber. The ratio between the quantity of water introduced and the fuel is generally referred to as parameter ω.

With reference to the block diagram depicted in FIG. 1, it is shown a logic pertaining to the state of the art for the ω control during operation. Currently the ω is kept equal to a value ω₁ for a predefined time period (block 100) after starting the engine for cold ambient temperatures. Then, the ω is adjusted to the normal operation set point ω₂ (block 200). However, such control logic just keeps a single operating point which does not ensure optimum combustion behaviour in terms of NOₓ emissions and pulsations.

In fact, this way the NOₓ emissions are high during the complete warming up phase, and may be higher than the limit defined by law or local requirements. Moreover, after further warming up the pulsations may remain high and trigger protective events.

In general, with such arrangement it has proven to be difficult to adjust the engine for different ambient conditions.

### SUMMARY OF THE INVENTION

It is an object of the present invention to solve the aforementioned technical problem by providing a method for operating a combustion device as substantially defined according to independent claim 1.

It is a further object of the present invention to provide an apparatus for operating a combustion device as substantially defined in independent claim 5.

According to an aspect of the invention, this object is obtained by a method for operating a combustion device, the combustion device comprising a combustion chamber, a water injection system configured to mix water to fuel in the combustion chamber and to adjust a parameter ω defined as a ratio between water and fuel, the parameter ω having a normal operating set point value ωₙₒₘ, and a minimum value ωₘᵢₙ; and wherein the combustion device further comprises a controller for detecting flame-generated pulsations above a predefined threshold; wherein the method includes the steps of detecting a flame-generated pulsation event, calculating current parameter ω and:
if current ω is greater than ωₘᵢₙ, reducing parameter ω and subsequently increasing it to ωₙₒₘ;
if current ω is equal to ωₘᵢₙ, increasing parameter ω to ωₙₒₘ.

According to a preferred aspect of the invention, the parameter ω is adjusted based on a measured level of the detected flame-generated pulsation above the predefined threshold.

According to a preferred aspect of the invention, the parameter ω reduction is established substantially simultaneously with the detection of a flame-generated pulsation above the predefined threshold.

According to a preferred aspect of the invention, the parameter ω is increased as a linear function of time.

According to a further aspect of the invention, it is provided an apparatus for operating a combustion device, the combustion device being a combustion chamber, a water injection system configured to mix water to fuel in the combustion chamber and to adjust a parameter ω defined as a ratio between water and fuel, the parameter ω having a normal operating set point value ωₙₒₘ and a minimum value ωₘᵢₙ; and wherein the combustion device further comprises a controller for detecting flame-generated pulsations above a predefined threshold; wherein the apparatus comprises a control unit, connected to said water injection system and said pulsations controller, and configured to:
receive an input signal from the controller correspondent to a level of a detected flame-generated pulsation above a predefined threshold;
calculate current parameter ω;
send an output signal to the water injection system, wherein the output signal corresponds to a command for reducing current parameter ω and subsequently increasing it to ωₙₒₘ if current ω is greater than ωₘᵢₙ, or increasing parameter ω to ωₙₒₘ if current ω has reached ωₘᵢₙ.

According to a preferred aspect of the invention, the control unit is configured to adjust parameter ω based on a measured level of the detected flame-generated pulsation above a predefined threshold.

According to a preferred aspect of the invention, the control unit is configured to reduce parameter ω substantially simultaneously with the detection of a flame-generated pulsation above a predefined threshold.

According to a preferred aspect of the invention, the control unit is configured such that parameter ω is increased as a linear function of time.

As it will be clear by the description of exemplary embodiments of the invention, presented as non-limiting examples, with the innovative method and apparatus, involving dynamic pulsation control logic, the ω of the water/oil emulsion at the fuel oil lances is adapted, while optimum pulsation and NOₓ limits are guaranteed.

Advantageously, a pulsation protective load shedding (PLS) is avoided by quickly adjusting the parameter ω (water/oil ratio) in case of too high combustion pulsation levels from the standard operation set point. This implies that the dynamic pulsation control logic (P.C.L.) is activated in case the high frequency pulsation level exceeds a predetermined threshold value and a control unit adjusts the ω, preferably in a stepwise manner, until acceptable and optimum pulsation levels are reached or a maximum reduction of the ω is performed. The ω reduction is limited in order to ensure that NOₓ emissions are not exceeding legal limits and because the pulsations may increase again due to too low ω.

Additionally, in case the ω is reduced by a high pulsation spike, i.e. because of cold engine, low ambient temperature or after start-up in the morning, the ω may be ramped up slowly again to the standard operation set point, particularly as a linear function of time. In case the pulsation level exceeds the trigger limit again during the co ramping up, the PCL controller may be triggered again and the process repeated.

When the engine is loaded up and the pulsation level exceeds a certain threshold, the ω is reduced, preferably in one step, that is substantially simultaneously with the detection of the spike, and then slowly increased again (as a linear function of time having a predefined tilt) until reaching the normal operating set point. If during the ω ramping up another pulsation is detected, then a subsequent ω reduction will be carried out. A maximum reduction of the ω (which defines a ωₘᵢₙ) is ensured in order not to trigger other pulsation events.

The ω reduction involves a pulsation reduction but also a NOₓ increase.

According to preferred embodiments of the present invention, the warming up phase is advantageously taken into consideration in the new control logic, so several ω settings won't be needed anymore.

The engine is always adjusting to the lowest possible NOₓ, taking into account several ambient conditions.

Furthermore, ωₘᵢₙ and ω stepwise reduction are calculated/determined for a given relative load and ambient temperature, this way ensuring to remain below the NOₓ and pulsation limits.

### BRIEF DESCRIPTION OF THE DRAWINGS

The objects, advantages and other features of the present invention will become more apparent upon reading of the following non-restrictive description of preferred embodiments thereof, given for the purpose of exemplification only, with reference to the accompany drawing, through which similar reference numerals may be used to refer to similar elements, and in which:

FIG. 1 shows a simplified block diagram for a method of operating a combustion device according to the prior art;

FIG. 2 shows a simplified diagram of an apparatus for operating a combustion device according to the present invention;

FIG. 3 shows a block diagram depicting a method for operating a combustion device according to the present invention;

FIG. 4 depicts on top view a graph showing correlations between parameter ω and pulsations level for different operating scenarios, and on bottom view a graph showing the adjustment of parameter ω as a function of time according the method of the present invention;

FIGS. 5 and 6 depict graphs illustrating the correlations between w, pulsations and NOₓ emissions for different operating scenarios.

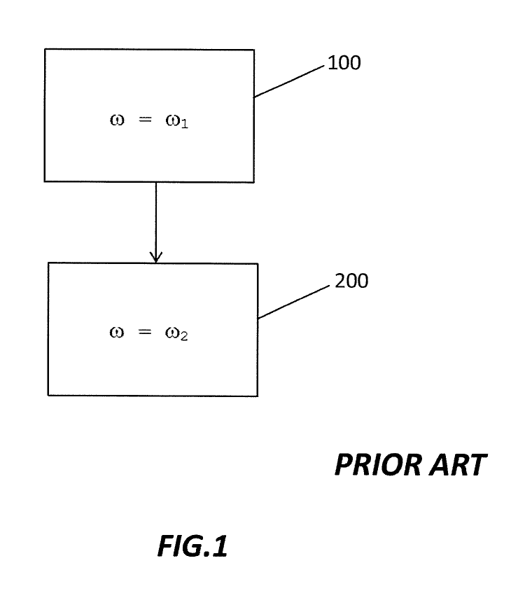

An exemplary preferred embodiment will be now described with reference to the aforementioned drawings.

### DETAILED DESCRIPTION OF THE INVENTION

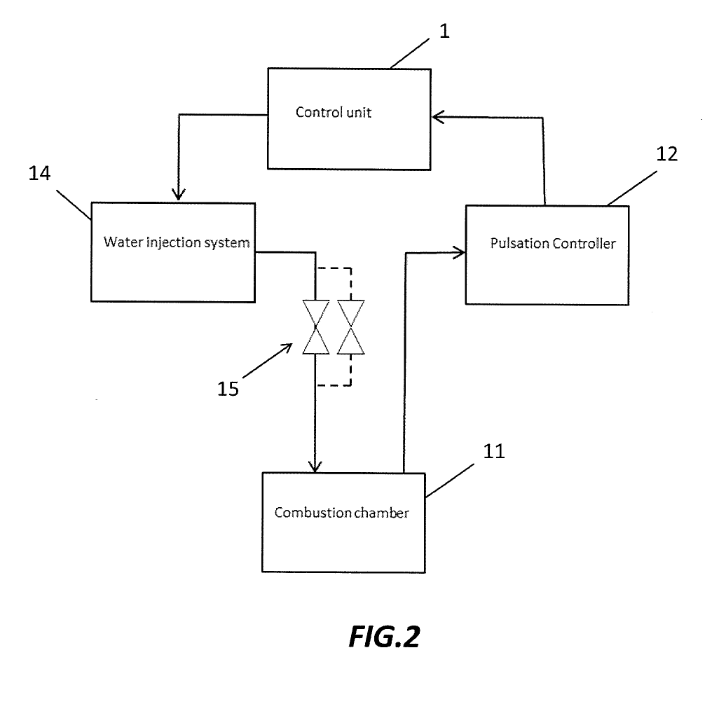

With reference to FIG. 2, it is shown a simplified diagram of an apparatus 1 for operating a combustion device according to the present invention.

The combustion device, to which the apparatus 1 according to the invention is associated, comprises a combustion chamber 11. The combustion chamber may comprise a premix burner equipped with fuel stagings.

Moreover, the combustion device comprises a water injection system 14 configured to mix/adjust a quantity of water to the fuel in the combustion chamber 11, thus determining a parameter ω which is defined as the ratio between water and fuel. The introduction of water into the combustion chamber may be operated by means of one or several intake valves 15.

During normal operation parameter ω, in other words the amount of water introduced in the combustion for a given fuel quantity, is set to a normal operating set point ωₙₒₘ.

The apparatus 1 according to the invention comprises a control unit 1 which is connected to the pulsation controller 12 and the water injection system 14.

In the event that the controller 12 detects a flame-generated pulsation increase occurring in the combustion chamber 11 having a level which is above a predefined threshold, an input signal is sent to the control unit 1 corresponding to the detected pulsation, being above the threshold. Then, the control unit calculates the current parameter ω and sends an output signal to the water injection system 14 corresponding to a command for adjusting ω.

Particularly, if the current ω is above a minimum value wₘᵢₙ, then ω is reduced and, subsequently, increased back to the operating set point ωₙₒₘ.

Preferably, the amount of ω reduction after the detection of a pulsation event is correlated to the magnitude of the detected pulsation level.

According to preferred embodiments, the reduction of ω which follows the pulsation detection, may be established substantially simultaneously with the occurrence of the detection of the pulsation being above the predetermined threshold. In other words, the new parameter ω is imposed by the water injection system 14 in one step/operation.

Once the ω has been reduced, it is subsequently increased gradually, particularly as a linear function of time, thus ramp-shaped. In other words, the introduction of water carried out by the water injection system is increased. If, after the detection of a pulsation event, the current w has reached ωₘᵢₙ, then the ω is only increased in a manner as above described.

If during the ramping up of the ω a further pulsation event is detected, then the process is repeated.

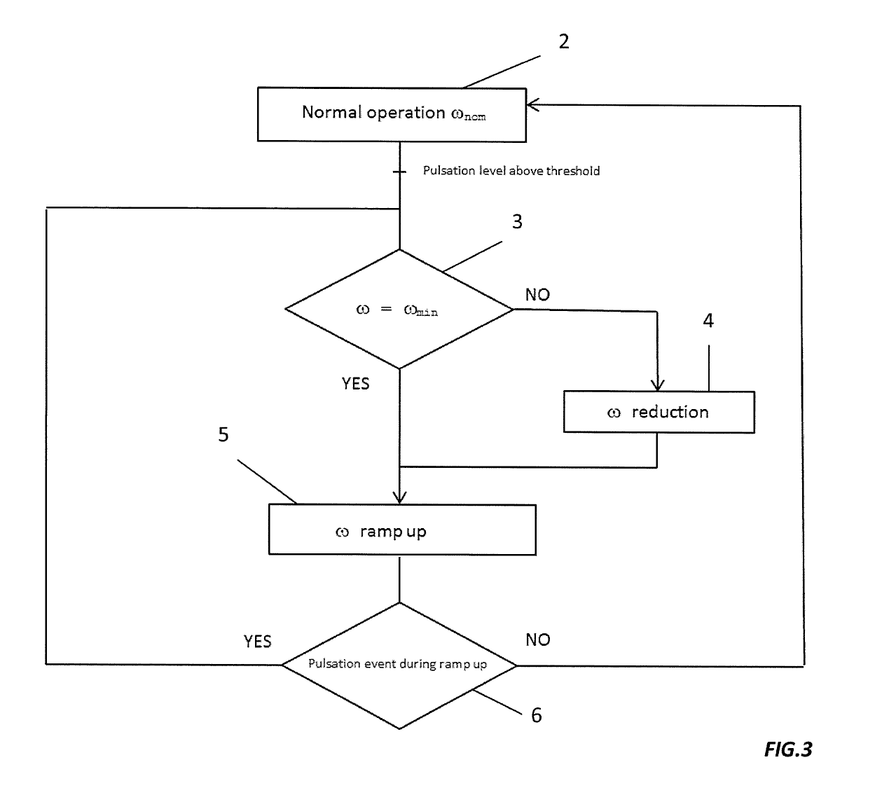

Making now reference to FIG. 3, it is depicted a block diagram showing the method for operating a combustion device according to the present invention.

In particular, block 2 identifies the normal operation. If a pulsation level above a predefined threshold is detected, then at block 3 the current value of w is calculated/verified. If ω is above ωₘᵢₙ, then the amount of water introduced in the combustion chamber is reduced, as indicated by block 4 (ω reduction).

Preferably, the amount of the reduction is based on the measured level of the detected pulsation. Furthermore, the w reduction is carried out substantially simultaneously to the detection of the pulsation, that means, that the new parameter ω is achieved in one step/operation, as explained above. After the reduction of ω, the latter is then increased, preferably stepwise, to the normal operating set point (block 5). If during the ramp up of the ω, another pulsation event is registered, the process is then repeated (block 6).

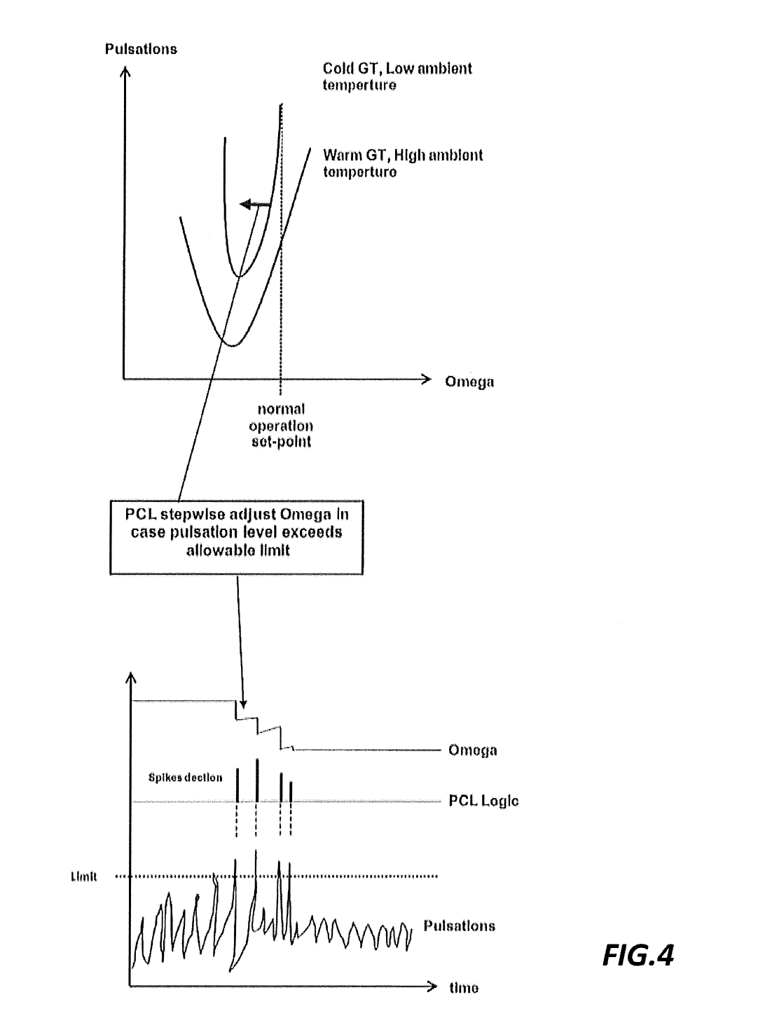

With reference to FIG. 4 top, it is depicted a correlation between parameter ω and level of pulsations for two operating scenarios. The graph shows that pulsation has a parabolic trend as a function of ω. In particular, the extent of the curve narrows for low ambient temperatures (or start-up phase, when the gas turbine is still cold) with respect to high ambient temperatures (or normal operating state).

The dashed line identifies the ω used in the normal operating set point, which is set as a compromise between an acceptable level of pulsation and NOₓ emissions. It is also clear from the graph that the ω for the normal operating set point depends on the operating conditions, for example ambient temperature and start-up phase. Turning to FIG. 4 bottom, it is depicted a graph showing how ω is adjusted as a function of time in the event of a detected pulsation having a level above a predefined threshold. In particular, the graph shows the level of registered pulsations occurring in the combustion chamber. Until pulsations remain below the threshold (indicated as “limit” in the graph), then the ω is kept constant and equal to the normal operating set point. When a pulsation going beyond the limit is detected, the ω is reduced by the water injection system in one step, this way resulting in a vertical line on the ω(t) function. After the ω has been set to a new value, then it is slowly increased. This is indicated by the ramp-shaped line on the ω(t) function. The graph shows that, during the ω ramp-up, another pulsation event is detected, then the process is repeated.

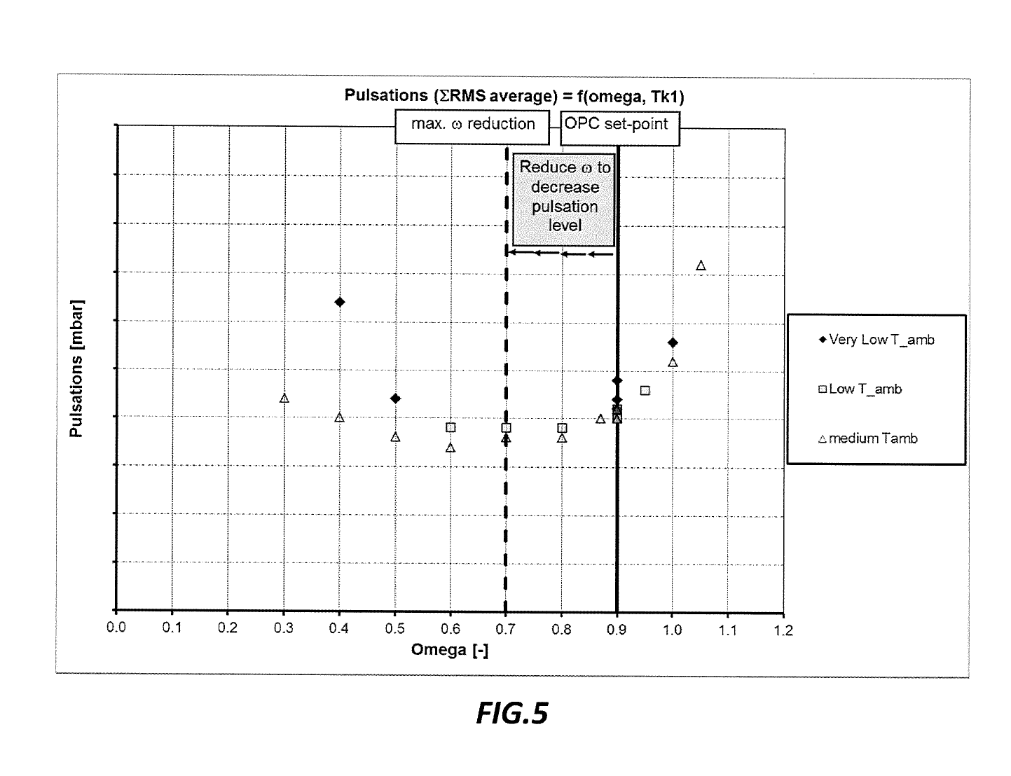

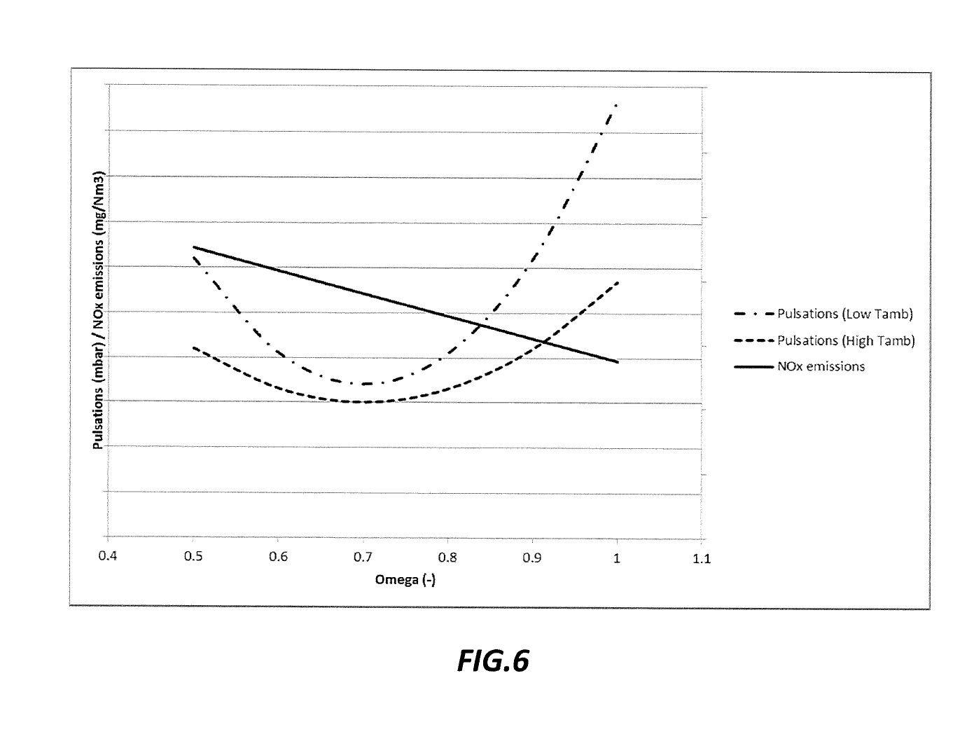

Next FIG. 5 depicts, similarly to FIG. 4 top, a graph better detailing the relationship between ω and pulsations with reference to low ambient temperatures. Finally, last FIG. 6 shows the relationship between ω and pulsations and between ω and NOₓ emissions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for operating a combustion device, the combustion device having: a combustion chamber; a water injection system configured to mix water to fuel in the combustion chamber and to adjust a parameter ω defined as a ratio between water and fuel, said parameter ω having an operating set point value ωₙₒₘ and a minimum value ωₘᵢₙ; and a controller for detecting flame-generated pulsations above a predefined threshold;
the method comprising:
detecting a flame-generated pulsation event;
calculating parameter ω and:
if ω is greater than ωₘᵢₙ, reducing parameter ω and subsequently increasing it to ωₙₒₘ;
if ω is equal to ωₘᵢₙ, increasing parameter ω to ωₙₒₘ.

2. The method according to claim 1, wherein said parameter ω is adjusted based on a measured level of the detected flame-generated pulsation above a predefined threshold.

3. The method according to claim 1, wherein said parameter ω reduction is established substantially simultaneously with the detection of a flame-generated pulsation above a predefined threshold.

4. The method according to claim 1, wherein parameter ω is increased as a linear function of time.

5. An apparatus for operating a combustion device, the combustion device comprising: a combustion chamber, a water injection system configured to mix water to fuel in the combustion chamber and to adjust a parameter ω defined as a ratio between water and fuel, said parameter ω having an operating set point value ωₙₒₘ and a minimum value ωₘᵢₙ;
a controller for detecting flame-generated pulsations above a predefined threshold;
a control unit connected to said water injection system and said controller, wherein said control unit is configured to:
receive an input signal correspondent to a level of a detected flame-generated pulsation above a predefined threshold;
calculate current parameter ω;
send an output signal to said water injection system, wherein said output signal corresponds to a command for reducing parameter ω and subsequently increasing it to ωₙₒₘ if ω is greater than ωₘᵢₙ, or increasing parameter ω to ωₙₒₘ if ω is equal to ωₘᵢₙ.

6. Apparatus according to claim 5, wherein said control unit is configured to adjust parameter ω based on a measured level of the detected flame-generated pulsation above a predefined threshold.

7. The apparatus according to claim 5, wherein said control unit is configured to reduce parameter ω substantially simultaneously with detection of a flame-generated pulsation above a predefined threshold.

8. The apparatus according to claim 5, wherein said control unit is configured such that parameter ω is increased as a linear function of time.
